(19) United States
(12) Patent Application Publication
(10) Pub. No.: US 2025/0126407 A1
(43) Pub. Date: Apr. 17, 2025

(54) MICROPHONE ARRAY AND SIGNAL CONVERSION APPARATUS

(71) Applicant: NIPPON TELEGRAPH AND TELEPHONE CORPORATION, Tokyo (JP)

(72) Inventors: Shoichiro SAITO, Tokyo (JP); Masahiro YASUDA, Tokyo (JP)

(73) Assignee: NIPPON TELEGRAPH AND TELEPHONE CORPORATION, Tokyo (JP)

(21) Appl. No.: 18/681,038

(22) PCT Filed: Aug. 6, 2021
(86) PCT No.: PCT/JP2021/029340

§ 371 Date: Feb. 3, 2024

(51) Int. Cl. H04R 5/027; H04R 3/00; H04S 7/00

(52) U.S. Cl. CPC H04R 5/027; H04R 3/005; H04S 7/00; H04S 2400/15; H04S 2420/11

(57) ABSTRACT

Provided is a microphone array for obtaining information equivalent to an Ambisonics type acoustic signal. The microphone array includes two fixing parts fixed to both ears of a user, and at least two microphones held by the fixing parts respectively, wherein when the fixing parts are fixed to both ears, the position of the microphone arranged on one ear side and the position of the microphone arranged on the other ear side are asymmetrical.

### TECHNICAL FIELD

The present invention relates to a technique for obtaining information equivalent to an Ambisonic type acoustic signal.

### BACKGROUND ART

In recent years, in addition to speech recognition and localization of sound sources such as speech, acoustic event detection has been extensively studied. This is based on the background that a means requiring recognition of ambient sound is required, regardless of voice. For example, as a technique for simultaneously performing acoustic event detection and sound source localization (SELD: sound event localization and detection), there has been proposed a technique such as that disclosed in NPL 1. This is a method for detecting an acoustic event from a voice recorded by an Ambisonics microphone.

### CITATION LIST

### Non Patent Literature

[NPL 1] Masahiro Yasuda, Yuma Koizumi, Shoichiro Saito, Hisashi Uematsu, Keisuke Imoto, “SOUND EVENT LOCALIZATION BASED ON SOUND INTENSITY VECTOR REFINED BY DNN-BASED DENOISING AND SOURCE SEPARATION,” IEEE ICASSP 2020.

### SUMMARY OF INVENTION

### Technical Problem

However, there are applications and environments in which the use of a dedicated Ambisonics microphone is not practical.

There is “binaural recording” as a highly practical means for collecting surrounding sounds by a wearable device. However, binaural recording is mainly based on “whether a person can hear a recorded sound naturally or not,” and is not always suitable for acoustic processing such as acoustic event detection and sound source localization. For example, in binaural recording, microphones are installed for each 1 ch of both ears in order to faithfully reproduce a state of listening to a human or a sound, and sufficient information for the acoustic processing is not always obtained.

The present invention has been made in view of this point, and an object thereof is to provide a microphone array which obtains information equivalent to an Ambisonics type acoustic signal having sufficient information for acoustic processing with a highly practical configuration.

### Solution to Problem

In order to solve the above problem, a microphone array for obtaining information equivalent to an Ambisonics type acoustic signal, the microphone array including: two fixing parts fixed to both ears of a user; and at least two microphones held by the fixing parts, wherein when the fixing parts are fixed to the respective ears, a position of the microphone arranged on one of the ears and a position of the microphone arranged on the other ear are asymmetrical.

### Advantageous Effects of Invention

Thus, the microphone array for obtaining information equivalent to an Ambisonics type acoustic signal having sufficient information for acoustic processing with a highly practical configuration can be realized.

### BRIEF DESCRIPTION OF DRAWINGS

FIG. 1A is a conceptual diagram illustrating a configuration of a microphone array system 1 of a first embodiment. FIG. 1B is a block diagram showing a functional configuration of a signal conversion device of FIG. 1A.

FIG. 2 is a conceptual diagram showing a configuration of the microphone array according to the first embodiment.

FIGS. 3A and 3B are conceptual diagrams showing a configuration of the microphone array according to the first embodiment.

FIG. 4 is a conceptual diagram showing a configuration of the microphone array according to the first embodiment.

FIG. 5 is a conceptual diagram showing a configuration of the microphone array according to the first embodiment.

FIG. 6 is a conceptual diagram for illustrating directivity realized by the microphone array according to the first embodiment.

FIG. 7 is a conceptual diagram for illustrating directivity realized by the microphone array according to the first embodiment.

FIG. 8 is a conceptual diagram showing a configuration of a microphone array according to a second embodiment.

FIGS. 9A and 9B are conceptual diagrams showing a configuration of the microphone array according to the second embodiment.

FIG. 10 is a block diagram showing a hardware configuration of the signal conversion device 13 according to an embodiment.

### DESCRIPTION OF EMBODIMENTS

Hereinafter, embodiments of the present invention will be described with reference to the drawings.

### First Embodiment

First, a first embodiment of the present invention will be described.

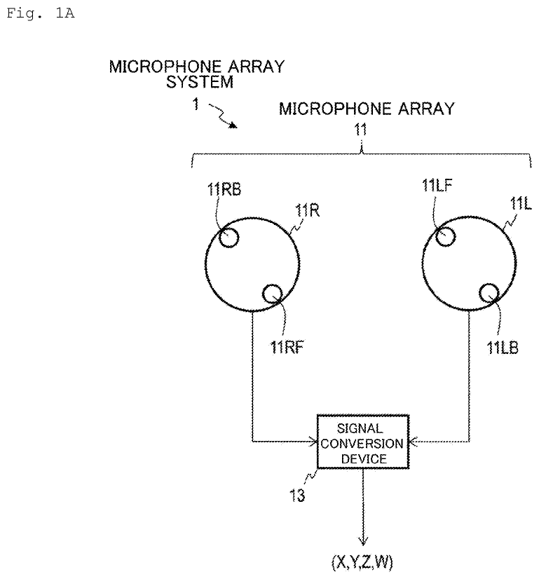

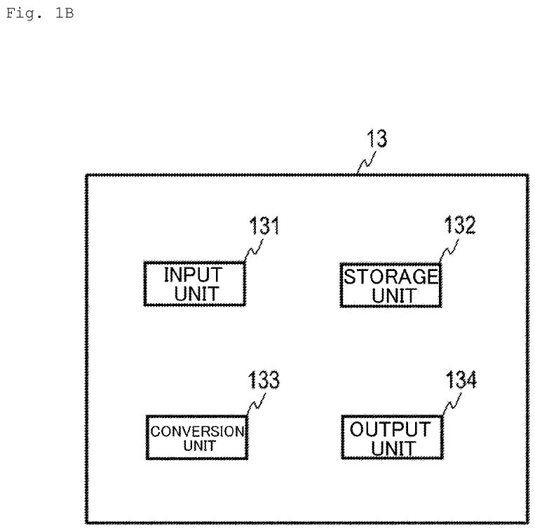

As illustrated in FIG. 1A, a microphone array system 1 of the first embodiment includes a microphone array 11 and a signal conversion device 13.

### <Microphone Array 11>

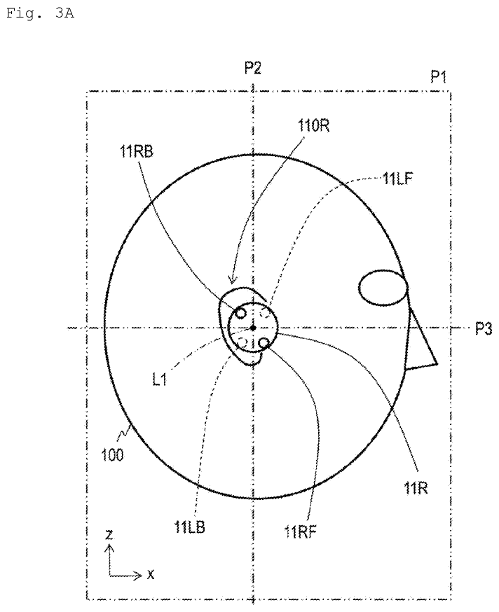

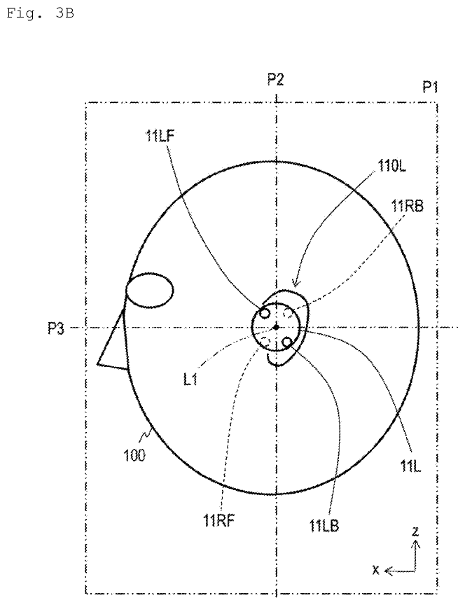

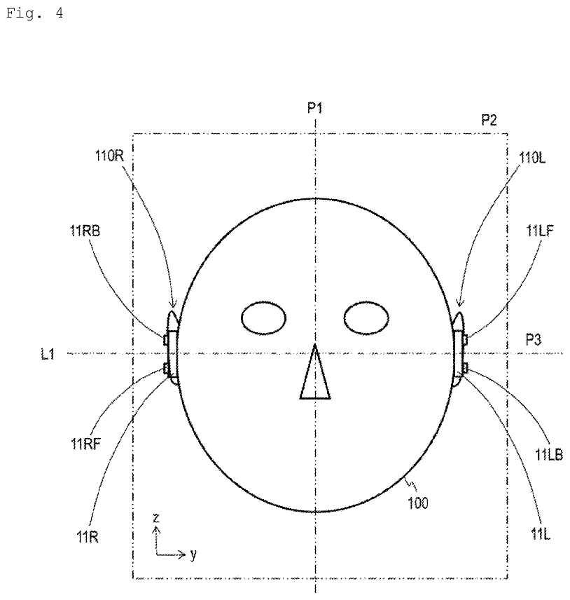

As illustrated in FIGS. 1A, 2, 3A, 3B, 4 and 5, the microphone array 11 according to the present embodiment is for obtaining information equivalent to an Ambisonics type acoustic signal, and includes two fixing parts 11R, 11L fixed to both ears 110R, 110L of a user 100, and microphones 11RF, 11RB, 11LF, 11LB held by the fixing parts 11R, 11L at least two by two.

The microphones 11RF, 11RB, 11LF, and 11LB of the present embodiment are, for example, microphones of non-directivity (omnidirectional). The microphones 11RF and 11RB may be fixed to the fixing part 11R or may be incorporated in the fixing part 11R. Similarly, the microphones 11LF, 11LB may be fixed to the fixing part 11L or may be incorporated in the fixing part 11L.

The fixing part 11R is configured to be fixed (attached) to the right ear 110R (one of the ears) of the user 100. The microphones 11RF and 11RB are arranged at positions where the sound observed by the microphones 11RF and 11RB is affected by the head of the user 100 but is not affected (not significantly affected) by the auricle when the fixing part 11R is fixed to the right ear 110R. For example, when the fixing part 11R is fixed to the right ear 110R, the sound pickup ends of the microphones 11RF, 11RB are not arranged on the inner side of the auricle of the right ear 110R but arranged on the outer side of the auricle of the right ear 110R. Preferably, when the fixing part 11R is fixed to the right ear 110R, the sound pickup ends of the microphones 11RF, 11RB are configured to face the outside of the user 100. For example, the microphones 11RF, 11RB are provided on the outer side (one side) of the fixing part 11R, and the sound pickup ends of the microphones 11RF, 11RB face the outer side and project to the outer side, and the other side (the other side) of the fixing part 11R is configured to be attachable to the right ear 110R. For example, the other side of the fixing part 11R is configured to be attachable to an auricle or a hole (external auditory canal) of the right ear 110R.

The fixing part 11L is configured to be fixed (attached) to the left ear 110L (the other ear) of the user 100. The microphones 11LF, 11LB are arranged at positions where sound observed by the microphones 11LF, 11LB is affected by the head of the user 100 but not affected (not significantly affected) by the auricle when the fixing part 11L is fixed to the left ear 110L. For example, when the fixing part 11L is fixed to the left ear 110L, the sound pickup ends of the microphones 11LF, 11LB are not arranged on the inner side of the auricle of the left ear 110L but arranged on the outer side of the auricle of the left ear 110L. Preferably, when the fixing part 11L is fixed to the left ear 110L, the sound pickup ends of the microphones 11LF, 11LB are configured to face the outside of the user 100. For example, the microphones 11LF, 11LB are provided on the outer side (one side) of the fixing part 11L, and the sound pickup ends of the microphones 11LF, 11LB face the outer side and project to the outer side, and the other side (the other side) of the fixing part 11L is configured to be attachable to the left ear 110L. For example, the other side of the fixing part 11L is constituted so as to be attachable to an auricle or a hole of the left ear 110L.

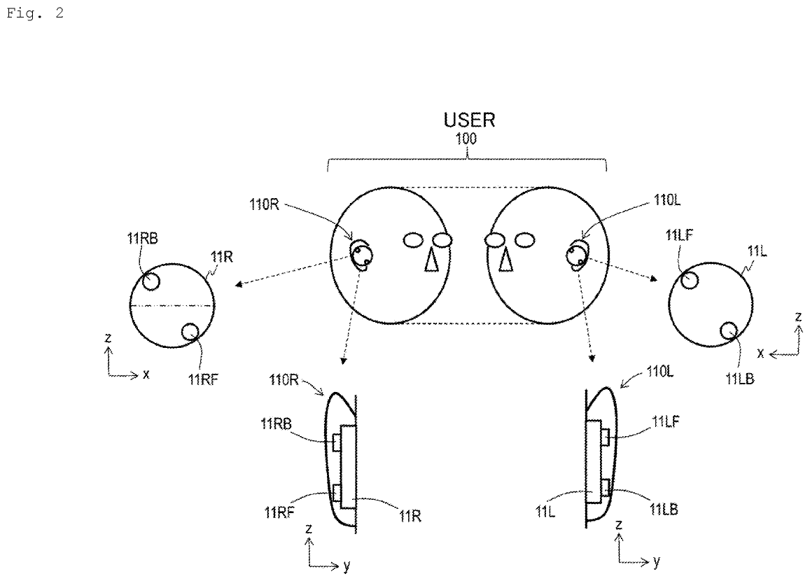

Also, as shown in FIGS. 2, 3A, 3B, 4, and 5, when the user 100 wears the microphone array 11 and the fixing parts 11R and 11L are fixed (attached) to both ears 110R and 110L, respectively, the positions of the microphones 11RF and 11RB arranged on the right ear 110R side (one ear side), the positions of the microphones 11F and 11LB arranged on the left ear 110L side (the other ear side) are asymmetrical. For example, the positions of the microphones 11RF, 11RB arranged on the right ear 110R side (one ear side) and the positions of the microphones 11LF, 11LB arranged on the left ear 110L side (the other ear side) are configured so as to be asymmetrical (non-symmetrical relation) with respect to a reference plane P1 (first reference plane) positioned between the right ear 110R side (one ear side) and the left ear 110L side (the other ear side).

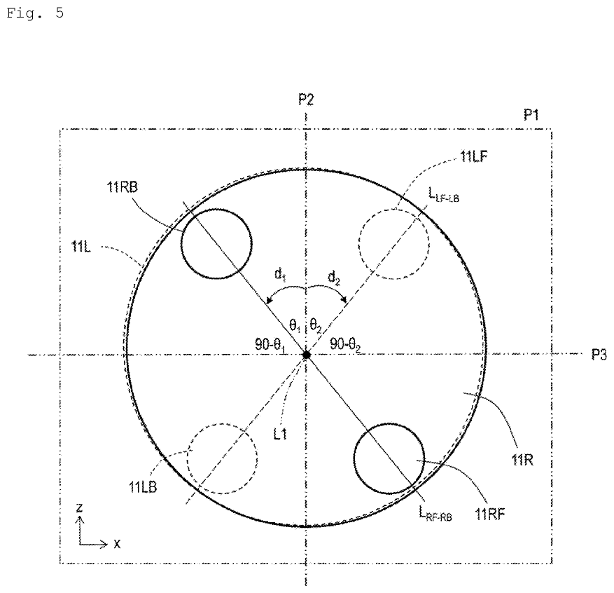

When the fixing parts 11R, 11L are fixed to both ears 110R, 110L, respectively, as shown in FIG. 5, a straight line L_{RF-RB} (first straight line) passing through the two microphones 11RF, 11RB arranged on the right ear 110R side (one ear side) is inclined at an angle θ₁° (first angle) in a rotation direction d₁ (first rotation direction) centering on an axis L1, with respect to a reference plane P2 (second reference plane) including the axis L1 of the straight line passing through the right ear 110R (one of the ears) and the left ear 110L (the other ear). The reference plane P2 (second reference plane) at this moment includes, for example, a center line of the user 100 (for example, a line connecting upper and lower parts of the head). In this case, a straight line L_{LF-LB} (second straight line) passing through the two microphones 11LF, 11LB arranged on the left ear 110L side (the other ear side) is inclined at an angle θ₂° (second angle) in a rotation direction d₂ (second rotation direction) centering on the axis L1, with respect to the reference plane P2 (second reference plane). Here, the rotation direction d₂ (second rotation direction) is a reverse rotation direction of the rotation direction d₁ (first rotation direction), and the angle θ₂° (second angle) is substantially the same as the angle θ₁° (first angle). Here, θ₁ and θ₂ are positive real numbers satisfying 0<θ₁, θ₂<90. In the present embodiment, the rotation direction d₁ is the left rotation direction, and the rotation direction d₂ is the right rotation direction, but the rotation direction d₁ is the right rotation direction, and the rotation direction d₂ may be the left rotation direction. For example, θ₁ and θ₂ are 45 (°) or around 45 (°), but this does not limit the present invention, and θ₁ may not be the same value as or around θ₂, or θ₁ and θ₂ may be a value other than (°). When θ₁ and θ₂ are 45 (°) or around 45 (°), the positional relationship between the microphones 11RF and 11RB arranged on the right ear 110R side (one ear side) is orthogonal or substantially orthogonal to the positional relationship between the microphones 11LF and 11LB arranged on the left ear 110L side (the other ear side). In other words, in this case, the straight line L_{RF-RB} (first straight line) and the straight line L_{LF-LB} (second straight line) are orthogonal or substantially orthogonal.

The following description will be made with reference to an orthogonal coordinate system based on an x-axis, a y-axis and a z-axis. Here, for convenience, when the fixing parts 11R, 11L are fixed to both ears 110R, 110L, an axis parallel to the axis L1 of the straight line passing through the right ear 110R and the left ear 110L is defined as the y-axis, and a direction from the right ear 110R to the left ear 110L is defined as a positive direction of the y-axis. The x-axis and the z-axis are orthogonal to the y-axis, an axis parallel to the longitudinal direction of the user 100 is defined as the x-axis, a front direction of the user 100 is defined as a positive direction of the x-axis, an axis parallel to the center line of the user 100 (an axis parallel to the vertical direction of the user 100) is defined as the z-axis, and an upper direction of the user 100 is defined as a positive direction of the z-axis.

As illustrated in FIGS. 2, 3A, 3B, 4, and 5, the fixing parts 11R, 11L are formed of plate-like members (for example, disk-shaped members), and when the fixing parts 11R, 11L are fixed to both ears 110R, 110L, the plate surfaces of the fixing parts 11R, 11L are arranged along the xz plane. In so doing, the microphones 11RF, 11RB held by the fixing part 11R are arranged on the outside (negative direction of the y-axis) side with respect to the fixing part 11R, and the microphones 11LF, 11LB held by the fixing part 11L are arranged on the outside (positive direction of the y-axis) side with respect to the fixing part 11L. As shown in FIG. 5, the direction from the axis L1 of the microphone 11RB held by the fixing part 11R arranged along the xz plane is the direction in which rotation is made by (90−θ₁)° in the rotation direction d₂ from a reference plane P3 (a plane including the axis L1 and parallel to the xy plane). The direction from the axis L1 of the microphone 11RB held by the fixing part 11R is the direction in which rotation is made by (90−θ₁)° in the rotation direction d₂ from the reference plane P3. Similarly, the direction from the axis L1 of the microphone 11LB held by the fixing part 11L arranged along an xz plane is a direction rotated by (90−θ2)° in the rotation direction d₁ from the reference plane P3. The direction from the axis L1 of the microphone 11LB held by the fixing part 11L is the direction in which rotation is made by (90−θ₂)° in the rotation direction d₁ from the reference plane P3.

The positions of the microphones 11RF, 11RB arranged on the right ear 110R side (one ear side) and the positions of the microphones 11LF, 11LB arranged on the left ear 110L side (the other ear side) are asymmetrical. For example, the positions of the microphones 11RF and 11RB and the positions of the microphones 11LF and 11LB are planarly asymmetric with respect to the reference plane P1 (first reference plane) parallel to the yz plane positioned between the right ear 110R side (one ear side) and the left ear 110L side (the other ear side).

As shown in FIG. 5, the straight line L_{RF-RB} (first straight line) passing through the microphones 11RF, 11RB is inclined at the angle θ₁° (first angle) in the rotation direction d₁ (first rotation direction) centering on the axis L1, with respect to the reference plane P2 (second reference plane) parallel to the yz plane and including the axis L1 and the center line of the user 100. The straight line L_{LF-LB} (second straight line) passing through the microphones 11LF, 11LB is inclined at the angle θ₂° (second angle) in the rotation direction d₂ (second rotation direction) centering on the axis L1, with respect to the reference plane P2 (second reference plane). Here, the rotation direction d₂ (second rotation direction) is a reverse rotation direction of the rotation direction d₁ (first rotation direction), and the angle θ₂° (second angle) is substantially the same as the angle θ₁° (first angle). That is, the positions (images) obtained by projecting the positions of the microphones 11RF, 11RB on the xz plane are different from the positions obtained by projecting the positions of the microphones 11LF, 11LB on the xz plane, and they are line-symmetrical with respect to a straight line parallel to the z-axis passing through the axis L1.

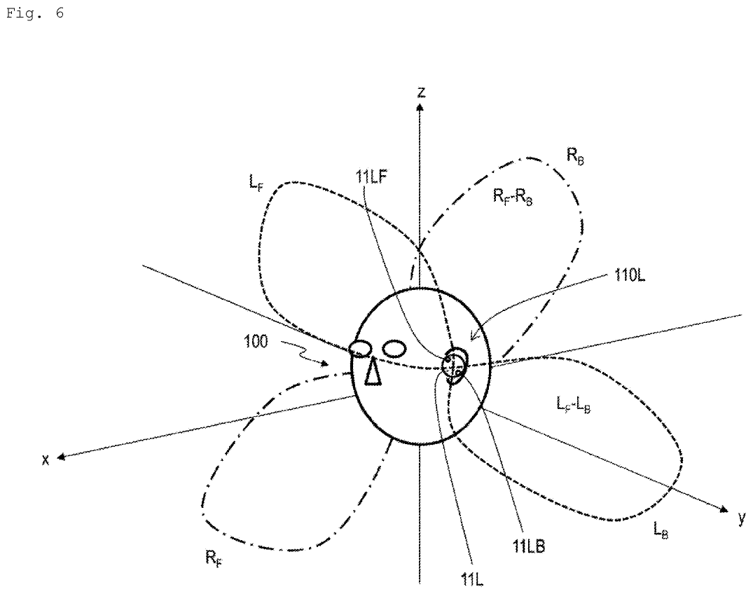

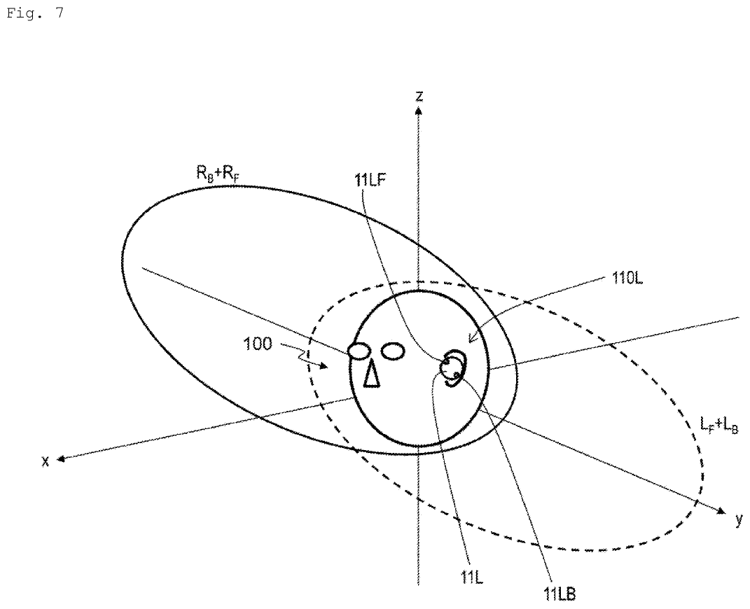

Next, the intention of arranging the microphones 11LF, 11LB, 11RF and 11RB in this manner will be described with reference to FIGS. 6 and 7. Acoustic signals collected by the microphones 11LF, 11LB, 11RF, 11RB are expressed as L_{F}, L_{B}, R_{F}, R_{B}, respectively. Namely, L_{F} is an acoustic signal obtained by the microphone 11RF arranged on the positive direction side (first direction side, front direction side of the user 100) of the x-axis among the two microphones 11RF, 11RB arranged on the right ear 110R side (one ear side), L_{B} is an acoustic signal obtained by the microphone 11RB arranged on the negative direction side (on the second direction side opposite of the first direction side) of the x-axis among the two microphones 11RF, 11FB, and R_{F} is an acoustic signal obtained by the microphone 11LF arranged on the positive direction side (the first direction side) of the x-axis among the two microphones 11LF and 11LB arranged on the left ear 110L side (the other ear side), and R_{B} is an acoustic signal obtained by the microphone 11LB arranged on the negative direction side (the second direction side) of the x-axis among the two microphones 11LF, 11LB.

First, when the microphones 11RF, 11RB, 11LF, 11LB are omnidirectional microphones, the difference R_{F}−R_{B} between the acoustic signals R_{F}, R_{B} obtained by the microphones 11RF, 11RB on the right ear 110R side, and the difference L_{F}−L_{B} between the acoustic signals L_{F}, L_{B} obtained by the microphones 11LF and 11LB on the left ear 110L side, can be regarded as acoustic signals observed by the microphones having bidirectionality (FIG. 6). Furthermore, the combination of the difference R_{F}−R_{B} and the difference L_{F}−L_{B} can be regarded as an acoustic signal observed by a microphone having directivity in the x-axis direction and the z-axis direction.

The sum R_{F}+R_{B} of the acoustic signals R_{F}, R_{B} obtained by the microphones 11RF and 11RB on the right ear 110R side can be regarded as an acoustic signal observed by a microphone having gentle directivity in the positive direction of the y-axis, while the higher the frequency, the stronger the shielding by the head of the user 100 becomes, and the lower the sensitivity becomes, on the negative direction side of the y-axis. Similarly, the sum L_{F}+L_{B} of the acoustic signals L_{F}, L_{B} obtained by the microphones 11LF, 11LB on the left ear 110L side can be regarded as an acoustic signal observed by a microphone having gentle directivity in the negative direction of the y-axis, while the higher the frequency, the stronger the shielding by the head of the user 100 becomes, and the lower the sensitivity becomes, on the positive direction side of the y-axis. The difference between the sum R_{F}+R_{B} and the sum L_{F}+L_{B} can be regarded as an acoustic signal observed by a microphone having directivity in a pseudo y-axis direction.

Thus, for example, the following expressions (1) to (4) are used, and signals (X, Y, Z, W) in a B format of the primary Ambisonics can be artificially generated from the acoustic signals R_{F}, R_{B}, L_{F}, L_{B}.

$$X = {L}_{F} - {L}_{B} + {R}_{F} - {R}_{B} \qquad ( 1 )$$

$$Y = {L}_{F} - {R}_{B} + {L}_{B} - {R}_{F} \qquad ( 2 )$$

$$Z = {L}_{F} - {L}_{B} + {R}_{B} - {R}_{F} \qquad ( 3 )$$

$$W = {L}_{F} + {L}_{B} + {R}_{B} + {R}_{F} \qquad ( 4 )$$

Here, X represents a directional component of the x-axis direction, Y represents a directional component of the y-axis direction, Z represents a directional component of the z-axis direction, and W represents a non-directional component. In actuality, since observation points at both ears are separated and there is an influence of the head of the user 100 as a rigid sphere, the results of the expressions (1) to (4) do not strictly coincide with the B-format signals (X, Y, Z, W) of the primary Ambisonics. However, it can be understood that the acoustic information of the user 100 in the vertical, horizontal and longitudinal directions can be obtained by the microphones 11LF, 11LB and the microphones 11RF, 11RB arranged asymmetrically in the left and right directions.

### <Signal Conversion Device 13>

As shown in FIG. 1B, the signal conversion device 13 according to the present embodiment includes an input unit 131, a storage unit 132, a conversion unit 133, and an output unit 134. The acoustic signals R_{F}, R_{B}, L_{F}, L_{B} obtained by the microphones 11RF, 11RB, 11LF, 11LB of the microphone array 11 are input to the input unit 131 and stored in the storage unit 132. The conversion unit 133 reads the acoustic signals R_{F}, R_{B}, L_{F}, L_{B} from the storage unit 132, and by using these acoustic signals, X=L_{F}−L_{B}+R_{F}−R_{B}, Y=L_{F}−R_{B}+L_{B}−R_{F}, Z=L_{F}−L_{B}+R_{B}−R_{F}, W=L_{F}+L_{B}+R_{B}+R_{F} are calculated and output according to the expressions (1) to (4). The output unit 134 outputs the obtained signals (X, Y, Z, W).

Alternatively, impulse responses from respective directions (known directions) obtained by the microphones 11RF, 11RB, 11LF, 11LB are used to obtain a model that eliminates or reduces the deviation between the signals (X, Y, Z, W) obtained according to the expressions (1) to (4) and the ideal primary Ambisonics B format signals. In this case, by the conversion unit 133 applying the signals (X, Y, Z, W) to the model, signals (X′, Y′, Z′, W′) in which the deviation is eliminated or reduced may be obtained and output. In this case, the output unit 134 outputs the signals (X′, Y′, Z′, W′).

### Characteristics of First Embodiment

The microphone array 11 of the present embodiment includes the two fixing parts 11R, 11L fixed to both ears 110R, 110L of the user 100, and microphones 11RF, 11RB, 11LF, 11LB held by the fixing parts 11R, 11L at least two by two, respectively, and when the fixing parts 11R, 11L are fixed to both ears 110R, 110L, the positions of the microphones 11RF, 11RB arranged on the right ear 110R (one ear side) and the positions of the microphones 11LF, 11LB arranged on the left ear 110L (the other ear side) are asymmetrical. Thus, an Ambisonics signal can be generated in a pseudo manner from the acoustic signals R_{F}, R_{B}, L_{F}, L_{B} obtained by the microphones 11RF, 11RB, 11LF, 11LB. By using them, acoustic processing such as acoustic event detection, sound source localization, and azimuth information detection of the surrounding environment of the user 100 can be performed on the basis of machine learning or the like.

The microphones 11RF, 11RB, 11LF, and 11LB are attached to both ears 110R and 110L of the user 100 via the fixing parts 11R and 11L, and are compatible with wearable devices or the like, and are highly practical.

The microphones 11RF, 11RB, 11LF, and 11LB of the present embodiment are arranged at positions where the sounds observed by them are affected by the head of the user 100 but are not affected by the auricle. Thus, it is possible to suppress the occurrence of individual differences in acoustic signals obtained by the microphones 11RF, 11RB, 11LF, and 11LB due to physical features of the user 100.

### Modifications of First Embodiment

As shown in FIG. 5, in the present embodiment, when the fixing parts 11R and 11L are fixed to both ears 110R and 110L, respectively, the straight line L_{RF-RB} (first straight line) passing through the microphones 11R, 11RB is inclined at the angle θ₁° (first angle) in the rotation direction d₁ (first rotation direction) centering on the axis L1, with respect to the reference plane P2 (second reference plane) including the center line of the user 100, that is, the reference plane P2 (second reference plane) parallel to the z-axis, and the straight line L_{LF-LB} (second straight line) passing through the microphones 11LF, 11LB is inclined at the angle θ₂° (second angle) in the rotation direction d₂ (second rotation direction) centering on the axis L1, with respect to the reference plane P2 (second reference plane). However, the present invention is not limited thereto. The straight line L_{RF-RB} (first straight line) passing through the microphones 11RF, 11RB may be inclined at the angle θ₁° (first angle) in the rotation direction d₁ (first rotation direction) centering on the axis L1, with respect to a reference plane P2′ (second reference plane) obtained by rotating the reference plane P2 including the axis L1 around the axis L1, and the straight line L_{LF-LB} (second straight line) passing through the microphones 11LF, 11LB may be inclined at the angle θ₂° (second angle) in the rotation direction d₂ (second rotation direction) centering on the axis L1, with respect to the reference plane P2′ (second reference plane).

### Second Embodiment

Next, a second embodiment of the present invention will be described.

The second embodiment is a modification of the first embodiment, and a spectacle-type device and a microphone boom are used together for arrangement of the microphones. Hereinafter, differences with the first embodiment will be mainly described, and the matters that have been described are given with the same reference numerals, and descriptions thereof are simplified accordingly.

In the microphone array system of the second embodiment, the microphone array 11 of the microphone array system 1 of the first embodiment is replaced with a microphone array 21. Hereinafter, the configuration of the microphone array 21 of the present embodiment will be described.

### <Microphone Array 11>

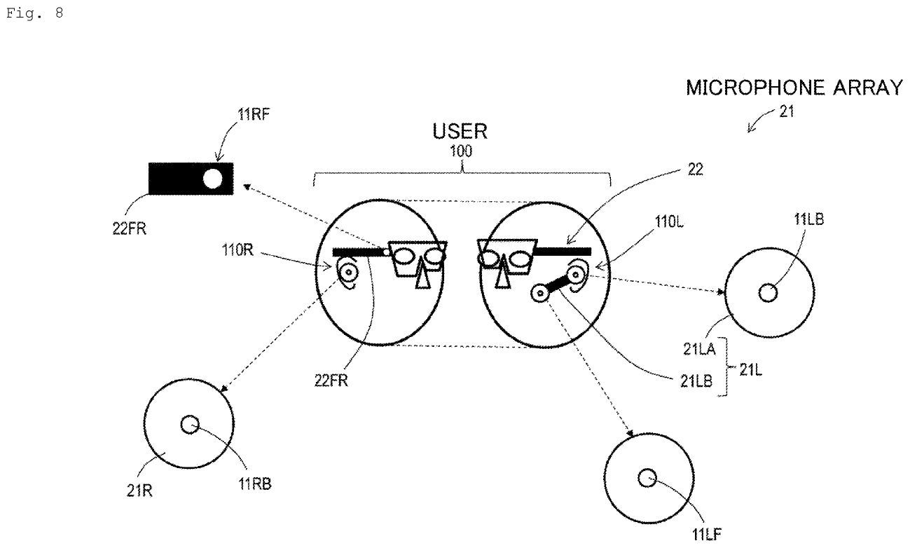

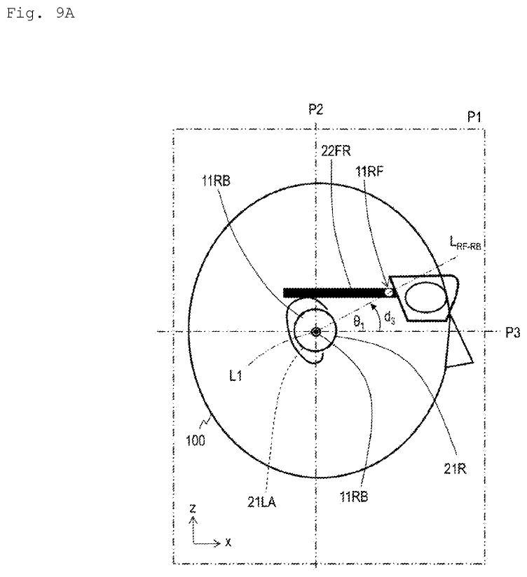

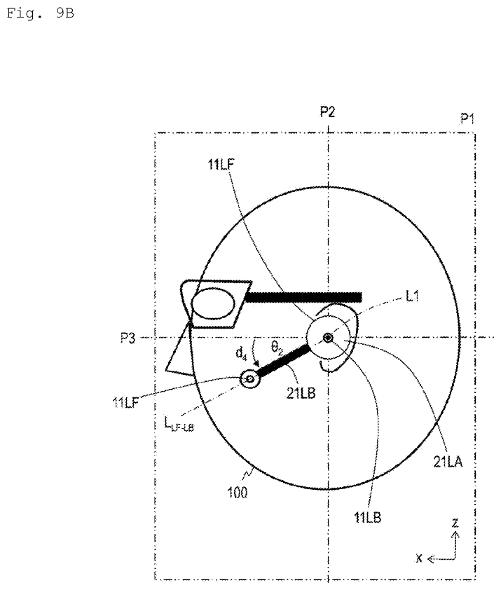

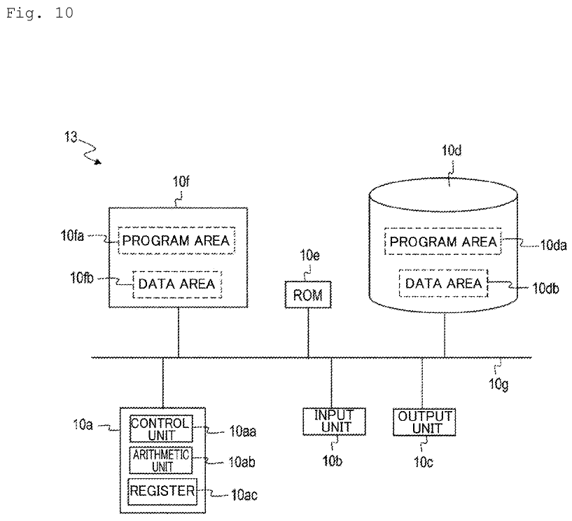

As shown in FIGS. 8 and 9, the microphone array 21 of this embodiment includes a fixing part 21R (first fixing part) fixed to the right ear 110R (one of the ears) of the user 100, a fixing part 21L (second fixing part) fixed to the left ear 110L (the other ear) of the user 100, a spectacle-type device 22 held by at least both ears 110R, 110L of the user 100, and a plurality of microphones 11RF, 11RB, 11LF, 11LB. The microphone 11RB (at least one of the microphones) is held by the fixing part 21R (first fixing part), the microphones 11LF and 11LB (at least two of the microphones) are held by the fixing part 21L (second fixing part), and the microphone 11RF (at least one of the microphones) is held by the spectacle-type device 22. In the example of the present embodiment, the microphone 11RF is held in a right frame 22FR of the spectacle-type device 22. For example, the microphone 11RF is held at an end of the right frame 22FR of the spectacle-type device 22 (an end on the side where the lens is attached). In an example of the present embodiment, the fixing part 21L (second fixing part) has a base part 21LA fixed to the left ear 110L (the other ear), and a rod-like microphone boom 21LB (extension part) extending from the base part 21LA. The microphone 11LB (at least one of the microphones) is held by the base part 21LA, and the microphone 11LF (at least one of the microphones) is held by the microphone boom 21LB (extension part). For example, the microphone 11LB is held at an end on the tip side of the microphone boom 21LB (extension part).

The fixing part 21R (second fixing part) is configured to be fixed (attached) to the right ear 110R (one of the ears) of the user 100. Similarly to the first embodiment, the microphone 11RB is arranged at a position where the sound observed by the microphone 11RB is affected by the head of the user 100 but is not affected (not significantly affected) by the auricle when the fixing part 21R is fixed to the right ear 110R. For example, when the fixing part 21R is fixed to the right ear 110R, the sound pickup end of the microphone 11RB is not arranged on the inner side of the auricle of the right ear 110R but arranged on the outer side of the auricle of the right ear 110R. Preferably, when the fixing part 21R is fixed to the right ear 110R, the sound pickup end of the microphone 11RB is configured to face the outside of the user 100. For example, the microphones 11RB are provided on the outer side (one side) of the fixing part 21R, the sound pickup ends of the microphones 11RB face the outer side and project to the outer side, and the other side (the other side) of the fixing part 21R is configured to be attachable to the right ear 110R. For example, the other side of the fixing part 21R is configured to be attachable to an auricle or a hole (external auditory canal) of the right ear 110R.

The base part 21LA of the fixing part 21L is configured to be fixed (attached) to the left ear 110L (the other ear) of the user 100. As with the first embodiment, the microphone 11LF is arranged at a position where the sound observed by the microphone 11LB is affected by the head of the user 100 but is not affected (not significantly affected) by the auricle when the base part 21LA is fixed to the left ear 110L. For example, when the base part 21LA is fixed to the left ear 110L, the sound pickup end of the microphone 11LB is not arranged on the inner side of the auricle of the left ear 110L but arranged on the outer side of the auricle of the left ear 110L.

Preferably, when the base part 21LA is fixed to the left ear 110L, the sound pickup end of the microphone 11LB is configured to face the outside of the user 100. For example, the microphones 11LB are provided on the outer side (one side) of the base part 21LA, the sound pickup ends of the microphones 11LB face the outer side and project to the outer side, and the other side (the other side) of the base part 21LA is configured to be attachable to the left ear 110L. For example, the other side of the base part 21LA is configured so as to be attachable to an auricle or a hole of the left ear 110L.

Since the microphone 11RF is held by the spectacle-type device 22, the sound observed by the microphone 11RF is affected by the head of the user 100 but is not affected (not significantly affected) by the auricle. Similarly, since the microphone 11LF is held by the microphone boom (extension part 21LB), the sound observed by the microphone 11LF is affected by the head of the user 100 but is not affected (not significantly affected) by the auricle.

As shown in FIGS. 8, 9A and 9B, when the user 100 wears the microphone array 21, the fixing part 21R (first fixing part) is fixed to the right ear 110R (one of the ears), the fixing part 21L (second fixing part) is fixed to the left ear 110L (the other ear), and the spectacle-type device 22 is held by both ears 110R and 110L (and nose), the microphones 11RF and 11RB held by the fixing part 21R (first fixing part) and the spectacle-type device 22 are arranged on the right ear 110R (one of the ears) side, the microphones 11LF and 11LB held by the fixing part 21L (second fixing part) are arranged on the left ear 110L (the other ear) side, and the positions of the microphones 11RF and 11RB arranged on the right ear 110R (one of the ears) side and the positions of the microphones 11LF and 11LB arranged on the left ear 110L (the other ear) side are asymmetrical. For example, the positions of the microphones 11RF, 11RB arranged on the right ear 110R side (one ear side) and the positions of the microphones 11LF, 11LB arranged on the left ear 110L side (the other ear side) are configured to be asymmetrical with respect to the reference plane P1 (first reference plane) positioned between the right ear 110R side (one ear side) and the left ear 110L side (the other ear side).

Also, as shown in FIGS. 8, 9A and 9B, when the fixing part 21R (first fixing part) is fixed to the right ear 110R (one ear), the fixing part 21L (second fixing part) is fixed to the left ear 110L (the other ear), and the spectacle-type device 22 is held by both ears 110R and 110L (and nose), the straight line L_{RF-RB} (first straight line) passing through the two microphones 11RF, 11RB arranged on the right ear 110R side (one ear side) is inclined at the angle θ₁° (first angle) in a rotation angle d₃ (first rotation angle) centering on the axis L1, with respect to the reference plane P3 (second reference plane) including the axis L1 of the straight line passing through the right ear 110R (one of the ears) and the left ear 110L (the other ear). The reference plane P3 (second reference plane) at this time includes, for example, a straight line (straight line parallel to the x-axis) in the longitudinal direction of the user 100, and is parallel to, for example, the xy plane. In this case, the straight line L_{LF-LB} (second straight line) passing through the two microphones 11LF, 11LB arranged on the left ear 110L side (the other ear side) is inclined at the angle θ₂° (second angle) in a rotation direction d₄ (second rotation direction) centering on the axis L1, with respect to the reference plane P3 (second reference plane). Here, the rotation direction d₄ (second rotation direction) is a reverse rotation direction of the rotation direction d₃ (first rotation direction), and the angle θ₂° (second angle) is substantially the same as the angle θ₁° (first angle).

The acoustic signals L_{F}, L_{B}, R_{F}, R_{B} collected by the microphones 11LF, 11LB, 11RF, 11RB are sent to the signal conversion device 13, and as described in the first embodiment, the signal conversion device 13 calculates and outputs X=L_{F}−L_{B}+R_{F}−R_{B}, Y=L_{F}−R_{B}+L_{B}−R_{F}, Z=L_{F}−L_{B}+R_{B}−R_{F}, W=L_{F}+L_{B}+R_{B}+R_{F} according to the expressions (1) to (4). Alternatively, by applying the signals (X, Y, Z, W) to the model described above, the signal conversion device 13 obtains and outputs signals (X′, Y′, Z′, W′) that eliminates or reduces the deviation between the signals (X, Y, Z, W) and the ideal primary Ambisonics B format signals.

### Characteristics of Second Embodiment

The microphone array 21 of the present embodiment includes the fixing part 21R (first fixing part) fixed to the right ear 110R (one of the ears) of the user 100, the fixing part 21L (second fixing part) fixed to the left ear 110L (the other ear) of the user 100, the spectacle-type device 22 held by at least both ears 110R, 110L of the user 100, and the plurality of microphones 11RF, 11RB, 11LF, 11LB. The microphone 11RB (at least one of the microphones) is held by the fixing part 21R (first fixing part), the microphones 11LF and 11LB (at least two of the microphones) are held by the fixing part 21L (second fixing part), and the microphone 11RF (at least one of the microphones) is held by the spectacle-type device 22. When the fixing part 21R (first fixing part) is fixed to the right ear 110R (one ear), the fixing part 21L (second fixing part) is fixed to the left ear 110L (the other ear), and the spectacle-type device 22 is held by both ears 110R and 110L (and nose), the microphones 11RF, 11RB held by the fixing part 21R (first fixing part) and the spectacle-type device 22 respectively are arranged on the right ear 110R (one ear) side, the microphones 11LF, 11LB held by the fixing part 21L (second fixing part) are arranged on the left ear 110L (the other ear) side, and the positions of the microphones 11RF, 11RB arranged on the right ear 110R (one ear) side and the positions of the microphones 11LF, 11LB arranged on the left ear 110L (the other ear) side are asymmetrical. Thus, an Ambisonics signal can be generated in a pseudo manner from the acoustic signals R_{F}, R_{B}, L_{F}, L_{B} obtained by the microphones 11RF, 11RB, 11LF, 11LB. By using them, acoustic processing such as acoustic event detection, sound source localization, and azimuth information detection of the surrounding environment of the user 100 can be performed on the basis of machine learning or the like.

The microphones 11RF, 11RB, 11LF, and 11LB are attached to the user 100, and have good compatibility with wearable devices or the like, and are highly practical.

The microphones 11RF, 11RB, 11LF, and 11LB of the present embodiment are arranged at positions where the sounds observed by them are affected by the head of the user 100 but are not affected by the auricle. Thus, it is possible to suppress the occurrence of individual differences in acoustic signals obtained by the microphones 11RF, 11RB, 11LF, and 11LB due to physical features of the user 100.

In the present embodiment, the spectacle-type device 22 holds the microphone 11RF, the fixing part 21R holds the microphone 11RB, the base part 21LA holds the microphone 11LB, and the microphone boom 21LB holds the microphone 11LB. Therefore, the distance between the microphone 11RF and the microphone 11RB and the distance between the microphone 11LF and the microphone 11LB can be made longer than the configuration of the first embodiment. This configuration is suitable for localization on the low frequency side. Further, as compared with the configuration of the first embodiment, since the microphone 11RF and the microphone 11LF on the front side are arranged on the further front side than both ears 110R and 110L on which the microphone 11RB and the microphone 11LB on the rear side are arranged, the difference between sounds before and after the user 100 is easily captured, and front and rear determination is easily performed.

### Modification of Second Embodiment

As in the modification of the first embodiment, if 01 is equal to or around 02, the straight line L_{RF-RB} (first straight line) passing through the microphones 11RF and 11RB is inclined at the angle θ₁ (first angle) in the rotation direction d₃ (first rotation direction) centering on the axis L1, with respect to the reference plane P3′ (second reference plane) obtained by rotating the reference plane P3 including the axis L1 about the axis L1, and the straight line L_{LF-LB} (second straight line) passing through the microphones 11LF, 11LB is inclined at the angle θ₂′ (second angle) in the rotation direction d₄ (second rotation direction) centering on the axis L1, with respect to the reference plane P3′ (second reference plane).

The second embodiment has illustrated an example in which the microphone 11LB is held at an end part on the tip side of the microphone boom 21LB (extension part). However, the second embodiment does not limit the present invention, and the microphone 11LB may be held on the root side (base part 21LA side) of the microphone boom 21LB or may be held in the middle of the microphone boom 21LB. In the second embodiment, the fixing part 21L (second fixing part) has the base part 21LA fixed to the left ear 110L (the other ear) and the rod-like microphone boom 21LB (extension part) extending from the base part 21LA, wherein the microphone 11LB (at least one of the microphones) is held by the base part 21LA, and the microphone 11LF (at least one of the microphones) is held by the microphone boom 21LB (extension part). However, the microphone 11LB and the microphone boom 21LB may be held by the base part 21LA similarly to the fixing part 11L of the first embodiment. In this case, the microphone boom 21LB may be omitted.

The second embodiment has also illustrated an example in which the microphone 11RF is held in the right frame 22FR of the spectacle-type device 22. The microphone 11RF may be held anywhere on the frame 22FR, or held at the end of the frame 22FR (the end on the side where the lens is attached), or held at the other end of the frame 22FR (the end on the side held by the ear 110R), or held at the middle of the frame 22FR. Further, the microphone 11RF may be held in other parts such as the vicinity of the lens of the spectacle-type device 22.

### [Hardware Configuration]

The signal conversion device 13 according to each of the embodiments is, for example, a device configured by causing a general-purpose or dedicated computer including a processor (hardware processor) such as a CPU (central processing unit) and a memory such as a RAM (random access memory) and a ROM (read-only memory) to execute a predetermined program. That is, the signal conversion device 13 of each embodiment has, for example, a processing circuit (processing circuitry) configured so as to mount each part of the signal conversion device 13. This computer may have one processor and one memory or may have a plurality of processors and a plurality of memories. This program may be installed in a computer or may be recorded in a ROM or the like in advance. Furthermore, some or all of the processing units may be configured by using an electronic circuit which realizes a processing function independently, instead of an electronic circuit (circuitry) such as a CPU which realizes a function configuration by reading a program. Further, an electronic circuit constituting one device may include a plurality of CPUs.

FIG. 6 is a block diagram showing a hardware configuration of the signal conversion device 13 according to each of the embodiments. As shown in FIG. 6, the signal conversion device 13 of this example includes a CPU (Central Processing Unit) 10a, an input unit 10b, an output unit 10c, a RAM (Random Access Memory) 10d, a ROM (Read Only Memory) 10e, an auxiliary storage device 10f, and a bus 10g. The CPU 10a of this example has a control unit 10aa, an arithmetic unit 10ab, and a register 10ac and executes various arithmetic processes in accordance with various programs read into the register 10ac. The input unit 10b is an input terminal to which data is inputted, a keyboard, a mouse, a touch panel, or the like. The output unit 10c is an output terminal from which data is outputted, a display, a LAN card controlled by the CPU 10a that has read a predetermined program, or the like. In addition, the RAM 10d is a static random access memory (SRAM), a dynamic random access memory (DRAM), or the like and has a program area 10da in which a predetermined program is stored and a data area 10db in which various data are stored. Moreover, the auxiliary storage device 10f is, for example, a hard disk, a magneto-optical (MO) disc, a semiconductor memory, or the like and has a program area 10fa in which a predetermined program is stored and a data area 10fb in which various data are stored. Furthermore, the bus 10g connects the CPU 10a, the input unit 10b, the output unit 10c, the RAM 10d, the ROM 10e, and the auxiliary storage device 10f so that information can be exchanged. The CPU 10a writes the program stored in the program area 10fa of the auxiliary storage device 10f to the program area 10da of the RAM 10d in accordance with the read operating system (OS) program. Likewise, the CPU 10a writes various types of data stored in the data area 10fb of the auxiliary storage device 10f into the data area 10db of the RAM 10d. Also, the address on the RAM 10d in which this program or data is written is stored in the register 10ac of the CPU 10a. The control unit 10aa of the CPU 10a sequentially reads these addresses stored in the register 10ac, reads the program or data from the area on the RAM 10d indicated by the read address, causes the arithmetic unit 10ab to sequentially execute the operations indicated by the program, and stores the arithmetic result in the register 10ac. With such a configuration, the functional configurations of the signal conversion device 13 are realized.

The above-mentioned program can be recorded on a computer-readable recording medium. An example of a computer-readable recording medium is a non-transitory recording medium. Examples of such recording media include a magnetic recording device, an optical disk, a magneto-optical recording medium, a semiconductor memory, and the like.

Further, distribution of this program is performed, for example, by selling, transferring, or renting a portable recording medium such as a DVD or CD-ROM on which the program has been recorded. Further, the program may be distributed by being stored in a storage device of a server computer and transferred from the server computer to another computer via a network. As described above, the computer which executes such a program first temporarily stores, for example, the program recorded on the portable recording medium or the program transferred from the server computer in its own storage device. Furthermore, when the process is performed, the computer reads the program stored in its own storage device and performs the process according to the read program. Furthermore, as another execution form of this program, a computer may read the program directly from a portable recording medium and execute processing according to the program and the processing according to the received program may be executed sequentially every time the program is transferred from the server computer to this computer. Furthermore, instead of transferring the program to the computer from a server computer, the processing described above may be executed by a so-called ASP (Application Service Provider) type service, in which a processing function is realized by execution commands and result acquisition alone. Note that the program in this embodiment includes information to be used for processing by a computer and equivalent to the program (data which is not a direct command to the computer but has a property that regulates the processing of the computer and the like).

Although the device is configured by executing a predetermined program on a computer in each embodiment, at least a part of these processing contents may be implemented by hardware.

Note that the present invention is not limited to the embodiments described above. For example, in the embodiments described above, the microphone was placed in the vicinity of both ears 110R, 110L of the user 100, in the vicinity of the tip of the microphone boom 21LB, and in the spectacle-type device 22. However, another microphone included in the microphone array may be installed at a position where a sound which is difficult to be observed by a certain microphone included in the microphone array can be easily observed. For example, a microphone may be attached to other parts such as hair and nose of the user 100. Further, “one of the ears” may be the left ear, and “the other ear” may be the right ear.

The microphone array may include five or more microphones. On the contrary, any one of the microphones 11RF, 11RB, 11LF, 11LB provided in the microphone array described above may be omitted. That is, when the microphone array is attached to the user 100, two microphones may be arranged on one ear side of the user 100, and one microphone may be arranged on the other ear side. Further, at least some of the microphones included in the microphone array may be the microphones having directivity such as single directivity and bi-directivity.

In the foregoing embodiments, the microphone arrays 11 and 21 are attached to the head of the user 100. However, a microphone array having a similar configuration may be attached to an object other than a human (a three-dimensional object having an acoustic shielding property). That is, the microphone array may include a plurality of attachment parts attached to a three-dimensional object having an acoustic shielding property, and a plurality of microphones held by the attachment parts, wherein when the attachment parts are attached to the three-dimensional object, at least two of the microphones may be arranged at a first attachment position on one side of the three-dimensional object, at least two of the microphones may be arranged at a second attachment position on the other side of the three-dimensional object, and the positions of the microphones arranged on one side of the three-dimensional object and the positions of the microphones arranged on the other side of the three-dimensional object may be configured to be asymmetrical. For example, the microphone array described above may be attached to an object, such as an animal such as a dog, a drone, a robot, or the like, to which an existing Ambisonics microphone cannot be attached. Alternatively, the microphone array described above may be attached to a drone or a robot in which the design of the housing cannot be changed.

In addition, the various types of processing described above may be executed not only in time series in accordance with the description but also in parallel or individually based on the processing capability of a device executing the processing or as needed. In addition, it goes without saying that changes can be made as appropriate without departing from the gist of the present invention.

### REFERENCE SIGNS LIST

11, 21 Microphone array
13 Signal conversion device
133 Conversion unit 133

1. A microphone array for obtaining information equivalent to an Ambisonics type acoustic signal, the microphone array comprising:
two fixing parts fixed to both ears of a user; and
a plurality of microphones held by each of the two fixing parts,
wherein, when the two fixing parts are fixed to the respective ears, a position of a first microphone of the plurality of microphones arranged on one ear side and a position of a second microphone of the plurality of microphones arranged on the other ear side are asymmetric.

2. A microphone array, comprising:
a first fixing part fixed to one ear of a user;
a second fixing part fixed to the other ear of the user;
a spectacle-type device held at least on both ears of the user; and
a plurality of microphones,
wherein at least one of the plurality of microphones is held by the first fixing part, at least two of the plurality of microphones are held by the second fixing part, at least one of the microphones is held by the spectacle-type device, and
when the first fixing part is fixed to the one ear, the second fixing part is fixed to the other ear, and the spectacle-type device is held by both ears;
the at least one of the plurality of microphones held by the first fixing part and the spectacle-type device respectively are placed on the one ear side, the at least two of the plurality of microphones held by the second fixing part are placed on the other ear side, and a position of the at least one of the plurality of microphones arranged on the one ear side and a position of the at least two of the plurality of microphones arranged on the other ear side are asymmetric.

3. The microphone array according to claim 2,
wherein the second fixing part comprises
a base part fixed to the other ear, and
an extension part extending from the base part,
wherein at least one of the microphones is held on the base part and at least one of the microphones is held on the extension part.

4. The microphone array according to claim 2,
wherein a position of the at least one of the plurality of microphones disposed on the one ear side and a position of the at least two of the plurality of microphones disposed on the other ear side are planarly asymmetric with respect to a first reference plane located between the one ear and the other ear.

5. The microphone array according to claim 2,
wherein a first straight line passing through two microphones of the at least two of the plurality of microphones arranged on the one ear side is inclined at a first angle in a first rotation direction centered on an axis, with respect to a second reference plane including an axis passing through the one ear and the other ear, and
a second straight line passing through the two microphones arranged on the other ear side is inclined at a second angle in a second rotation direction centering on the axis, with respect to the second reference plane,
the second rotation direction being a reverse rotation direction of the first rotation direction, and
the second angle being substantially the same as the first angle.

6. The microphone array according to claim 2,
wherein a first microphone of the plurality of microphones is arranged at a position where a sound observed by a second microphone of the plurality of microphones is affected by a head of the user but is not affected by an auricle of the user.

7. The microphone array according to claim 2, further comprising:
a signal conversion device comprising a processor configure to execute operations comprising:
calculating and outputting X=L_{F}−L_{B}+R_{F}−R_{B}, Y=L_{F}−R_{B}+L_{B}−R_{F}, Z=L_{F}−L_{B}+R_{B}−R_{F}, W=L_{F}+L_{B}+R_{B}+R_{F} by using:
an acoustic signal L_{F} obtained by a first microphone arranged on a first direction side among two microphones of the at least two of the plurality of microphones placed on the one ear side of the microphone array, and
an acoustic signal L_{B} obtained by a second microphone arranged on a second direction side which is a reverse direction side of the first direction side, an acoustic signal R_{F} obtained by the first microphone arranged on the first direction side among the two microphones of the at least two of the plurality of microphones placed on the other ear side, and an acoustic signal R_{B} obtained by a microphone arranged on the second direction side.

8. A microphone array for obtaining information equivalent to an Ambisonics type acoustic signal, the microphone array comprising:
a plurality of attachment parts attached to a three-dimensional object having an acoustic shielding property; and
a plurality of microphones held by the plurality of attachment parts,
wherein, when the plurality of attachment parts attaches to the three-dimensional object, at least two of the microphones are arranged at a first attachment position on one side of the three-dimensional object, at least two of the microphones are arranged at a second attachment position on the other side of the three-dimensional object, and
positions of the microphones arranged on one side of the three-dimensional object and positions of the microphones arranged on the other side of the three-dimensional object are asymmetric.
